(19) United States
(12) Patent Application Publication
(10) Pub. No.: US 2026/0214286 A1
(43) Pub. Date: Jul. 23, 2026

(54) METHOD, APPARATUS, DEVICE, STORAGE MEDIUM AND PROGRAM PRODUCT FOR REAL-TIME INTERACTION

(71) Applicant: Beijing Zitiao Network Technology Co., Ltd., Beijing (CN)

(72) Inventors: Ziyang ZHENG, Beijing (CN); Yifan DING, Beijing (CN); Siyu LIU, Beijing (CN)

(21) Appl. No.: 19/447,970

(22) Filed: Jan. 13, 2026

(30) Foreign Application Priority Data
Jan. 17, 2025 (CN) 202510083296.6

(51) Int. Cl. H04N 21/262; H04L 65/75; H04N 21/472; H04N 21/845

(52) U.S. Cl. CPC H04N 21/26258; H04L 65/762; H04N 21/47202; H04N 21/8456

(57) ABSTRACT

The embodiments of the disclosure provide a method, apparatus, device, storage medium and program product for real-time interaction. The method includes: determining, during a chat of a user with a digital assistant, whether to reply to a first user input with a content stream based on a user requirement indicated by the first user input; generating, in response to determining to reply to the first user input with the content stream, a first portion of streaming media content based on reply key information for the first user input; and presenting the streaming media content in the chat.

### CROSS-REFERENCE

This application claims the benefit of Chinese Patent Application No. 202510083296.6, filed on January 17, 2025, and entitled METHOD, APPARATUS, DEVICE, STORAGE MEDIUM AND PROGRAM PRODUCT FOR REAL-TIME INTERACTION”, the entirety of which is incorporated herein by reference.

### FIELD

Example embodiments of the present disclosure generally relate to the field of computers, and in particular, to a method, apparatus, device, computer-readable storage medium and computer program product for real-time interaction.

### BACKGROUND

With the rapid development of information technologies, various terminal devices may provide various services to people in terms of work and life. An application providing services may be deployed in the terminal device. The terminal device presents the corresponding content through the user interface of the application, implements the question-answering interaction with the user, and meets various requirements of the user. The terminal device or application may provide a digital assistant class function to the user to support better interaction with the user.

### SUMMARY

In a first aspect of the present disclosure, a method for real-time interaction is provided. The method comprises: determining, during a chat of a user with a digital assistant, whether to reply to a first user input with a content stream based on a user requirement indicated by the first user input; generating, in response to determining to reply to the first user input with the content stream, a first portion of streaming media content based on reply key information for the first user input; and presenting the streaming media content in the chat.

In a second aspect of the present disclosure, an apparatus for real-time interaction is provided. The apparatus comprises: a determination module configured to determine, during a chat of a user with a digital assistant, whether to reply to a first user input with a content stream based on a user requirement indicated by the first user input; a generation module configured to generate, in response to determining to reply to the first user input with the content stream, a first portion of streaming media content based on reply key information for the first user input; and a presentation module configured to present the streaming media content in the chat.

In a third aspect of the present disclosure, an electronic device is provided. The device includes at least ; and at least one memory coupled to the at least one processor and storing instructions executed by the at least one processor. The instructions, when executed by the at least one processor, cause the electronic device to perform the method of the first aspect.

In a fourth aspect of the present disclosure, a computer-readable storage medium is provided. The medium has computer programs stored thereon, wherein the computer programs are executable by the processor to perform the method of the first aspect.

It should be understood that the content described in this section is not intended to limit the key features or important features of the embodiments of the present disclosure, nor is it intended to limit the scope of the present disclosure. Other features of the present disclosure will become easily understood through the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a schematic diagram of an example environment in which embodiments of the present disclosure can be implemented;

FIG. 2 shows a schematic diagram of a first example interface for presenting streaming media content according to some embodiments of the present disclosure;

FIG. 3 shows a schematic diagram of another first example interface for presenting streaming media content according to some embodiments of the present disclosure;

FIG. 4 shows a schematic diagram of a further first example interface for presenting streaming media content according to some embodiments of the present disclosure;

FIG. 5 shows a schematic diagram of a second example interface for presenting streaming media content according to some embodiments of the present disclosure;

FIG. 6 shows a schematic diagram of another second example interface for presenting streaming media content according to some embodiments of the present disclosure;

FIG. 7 shows a schematic diagram of a further second example interface for presenting streaming media content according to some embodiments of the present disclosure;

FIG. 8 shows a flowchart of a process of real-time interaction according to some embodiments of the present disclosure;

FIG. 9 shows an example structural block diagram of an apparatus for real-time interaction according to some embodiments of the present disclosure; and

FIG. 10 shows a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms “including” and the like should be understood as open-ended inclusion, i.e., “including but not limited to”.. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below.

As used herein, unless stated explicitly, performing a step “in response to A” does not indicate that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It may be understood that before using the technical solutions disclosed in the embodiments of the present disclosure, relevant users should be informed of the types, use scope, usage scenarios, and the like of the information related to the present disclosure in an appropriate manner according to relevant laws and regulations, and the authorization of the related users may be obtained, wherein the relevant users may include any type of rights body, such as individuals, businesses, and groups.

For example, in response to receiving an active request of a user, prompt information is sent to the related user to explicitly prompt the related user that the requested operation will need to obtain and use the information of the related user, so that the related user can autonomously select whether to provide information to software or hardware, such as an electronic device, an application, a server or a storage medium, performing the operation of the technical solution of the present disclosure according to the prompt information.

As an optional but non-limiting implementation, in response to receiving an active request of a related user, a manner of sending prompt information to the related user may be, for example, a pop-up window, and the prompt information may be presented in a text manner in the pop-up window. In addition, the pop-up window may further carry a selection control for the user to select “agree” or “not agree” to provide information to the electronic device.

It may be understood that the above processes of notifying and obtaining a user authorization are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is completed. The generation of the model may be based on machine learning techniques. Deep learning is a machine learning algorithm that processes inputs and provides corresponding outputs by using a multi-layer processing unit. The neural network model is one example of a deep learning-based model. As used herein, the term “model” may also be referred to as a “machine learning model”, “learning model”, “machine learning network” or a “learning network” which terms are used interchangeably herein.

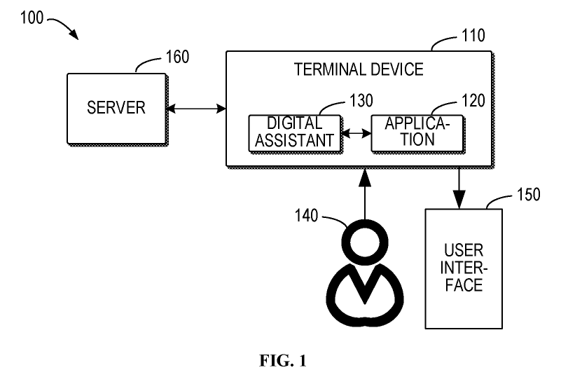

FIG. 1 shows a schematic diagram of an example environment 100 in which embodiments of the present disclosure can be implemented. In this example environment 100, a terminal device 110 is installed with a digital assistant 130 of an application 120. A user 140 may interact with the application 120 via the terminal device 110 and/or an attachment device of the terminal device 110. As an example, the application 120 may be a chat application (also referred to as an instant messaging application), a document application, an audio and video conference application, a mail application, a task application, a calendar application, an objective and key result (OKR) application, and the like. It may be understood that although a single application 120 is shown in FIG. 1, multiple applications 120 may be installed on the terminal device 110 practically.

The digital assistant 130 may be configured to have an intelligent dialog function. In the example shown in FIG. 1, the digital assistant 130 may be configured as a stand-alone application, such as a web application or other type of application. In other examples, the digital assistant 130 may be integrated within the application 120.

The user may interact with the digital assistant 130. During the interaction, the user inputs an interaction message, and the digital assistant 130 provides a reply message in response to the user input. Generally, the digital assistant 130 can support users to enter questions in a natural language manner and perform tasks and provide replies based on understanding of the natural language input and logical reasoning capabilities. In some embodiments, the interaction message with the application 120 may include a multimodal form of message, such as a text message (e.g., natural language text), a voice message, an image message, a video message, etc., depending on the configuration of the application 120.

In environment 100 of FIG. 1, the terminal device 110 may present a user interface 150 of the application 120. The user interface 150 may include various interfaces that the application 120 can provide, such as an interaction interface between the user 140 and the digital assistant 130. The interaction interface may include, for example, a chat window between the user 140 and the digital assistant 130.

In some embodiments, the digital assistant 130 may be associated to a corresponding database, which stores the data or information needed by the digital assistant 130 to answer the user interaction information. As an example, the digital assistant 130 may obtain the information indicated by the user from a database (for example, a knowledge base for storing historical interaction information between the user 140 and the digital assistant, or a database for storing guidance information or instruction information) connected to the application 120 in response to an user input. The digital assistant 130 may provide a corresponding answer to the user based on the question or requirement raised by the user according to the obtained operation data and device information.

In some embodiments, the terminal device 110 communicates with a server 160 to enable the provision of services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server 160 may be various types of computing systems/servers capable of providing computing power, including, but not limited to, mainframes, edge computing nodes, computing devices in a cloud environment, and the like.

It should be understood that the structures and functions of the various elements in the environment 100 are described only for example purposes and do not imply any limitation to the scope of the present disclosure.

As mentioned above, a terminal device or application may provide a service (such as an information query, text processing, etc.) to a user through a digital assistant. Generally, the digital assistant provides a service for the user in the form of voice or text for a service request input by the user. However, in some scenarios, the voice or text may not provide an intuitive and accurate service for the user, and the satisfaction of the user is often not high.

In view of the above, according to embodiments of the present disclosure, a solution for interaction is provided. It is determined, during a chat of a user with a digital assistant, whether to reply to a first user input with a content stream based on a user requirement indicated by the first user input. In response to determining to reply to the first user input with the content stream, a first portion of streaming media content (e.g., video) is generated based on reply key information for the first user input. The streaming media content is presented in the chat.

In this solution, if a pure voice or text reply cannot meet the user's requirement, streaming media content can be used to reply to the user more intuitively. In addition, such streaming media content is determined based on reply key points for the user input, and thus can provide an associated answer to the user input. In this way, a more pertinent reply can be provided to the user input. Therefore, the service accuracy and user experience provided by the digital assistant are improved.

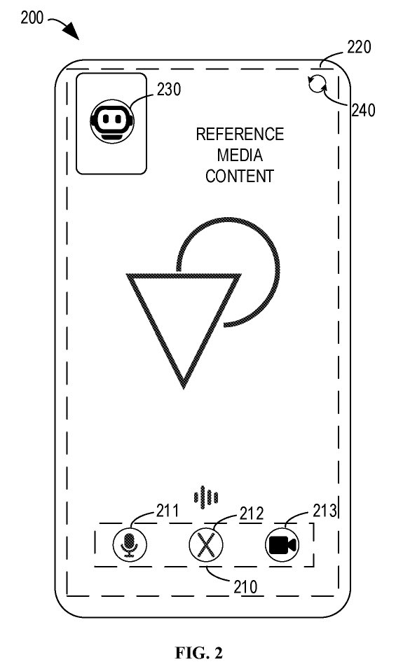

Some example embodiments of the present disclosure will be described below with continued reference to the accompanying drawings. FIGS. 2-4 show example interfaces 200 to 400 according to some embodiments of the present disclosure. The interface 200 to the interface 400 may be provided, for example, by the server 160 or the terminal device 110 shown in FIG. 1, or may be provided by the server 160 in cooperation with the terminal device 110. Here, the solution is described by taking the example interface provided by the server 160 as an example.

The digital assistant may provide services to users in the form of a chat. For example, the chat between the user and the digital assistant may include the form of a voice call or the form of text, or a combination thereof. The user provides a user input including the service request to the digital assistant 130 during the chat. After the digital assistant 130 generates an output for the user input, the output will be provided to the user in the chat. The digital assistant 130 may determine, based on the user's requirement, or the optimal representation of the reply content, to reply to the first user input in what form. In some embodiments, the server 160 determines, during the chat of the user with the digital assistant, whether to reply to the first user input with the content stream based on the user requirement indicated for the first user input of the digital assistant. In some embodiments, the machine learning model may be used to determine the semantics of the first user input, so as to determine the user requirement. The user requirement may include the type of service requested by the user. If the digital assistant 130 can accurately provide the corresponding service for the user in the form of a voice reply or a text reply, it may be unnecessary to reply to the first user input with the content stream. As an example, the user requirement may include a name explanation, a weather query, etc., and the corresponding information can be explicitly presented through a text reply or a voice reply, and no generation is required. If it is detected that the voice reply or the text reply of the digital assistant fails to meet the user requirement, it may be determined to reply to the first user input with the content stream. For example, if the user requirement includes content that fails to be explicitly presented by text or voice, such as question explanation, experimental guidance, etc., the first user input needs to be replied with the content stream. In some embodiments, the first user input may include a selection of a reply type by the user. As an example, the first user input may include “answer my question in the form of video”, “answer my question in the form of text”, and the like. In this case, the digital assistant 130 determines whether to reply to the first user input with the content stream based on the user requirement included in the first user input.

In some embodiments, the first user input may include reference media content related to the service request of the user. In some embodiments, the reference media content may be shot in real time by the user. For example, if a request for shooting the reference media content by the user is detected, the application 120 may invoke a sensor (for example, a camera) configured at the terminal device 110 in response to a trigger by the user for a shooting control, to determine an image and a video shot in real time by the user as the reference media content. In some embodiments, the reference media content may be media content uploaded by the user. For example, the application 120 may present an entry for receiving the reference media content to the user in response to the trigger by the user for a content upload control. Subsequently, the application 120 obtains, as the reference media content, locally stored images and videos uploaded by the user based on the entry.

In some embodiments, the user may provide indication information about the reference media content. Correspondingly, the reference media content may be determined based on the indication information provided by the user. The indication information may be in the form of text or voice. For example, the indication information provided by the user may include a storage path or an Internet link for the reference media content. For another example, the indication information provided by the user may be natural language. The user input is provided to a machine learning model (e.g., a large language model) to determine the reference media content based on the semantics of the user input.

In some embodiments, if it is determined to reply to the first user input with the content stream, the server 160 first generates reply key information for the first user input. The reply key information may be text content related to the first user input, for example, an outline of the reply for the first user input (such as key points for solving the test question, etc.). The reply key information may be a video frame or image related to the first user input. In some embodiments, the reply key information related to the first user input may be determined using a machine learning model, or the reply key information may be determined using a predetermined knowledge base. Subsequently, the streaming media content for replying to the first user input is generated based on the determined reply key information.

In some embodiments, the streaming media content may include a video stream or an audio stream. In the case that a chat of the digital assistant with the user is maintained, a first portion of the streaming media content is generated. In some embodiments, the streaming media content may be generated using a machine learning model. The server 160 may provide the first user input and the reference media content to the machine learning model. Subsequently, the video and the audio output by the machine learning model are obtained as the first portion of the streaming media content. The machine learning model takes as input the modality with which the user input has, and outputs the content of the modality that may be presented directly to the user without the transition of the modality (e.g., without voice-to-text conversion). In this way, the streaming media content is generated in an end-to-end manner, and efficiency of generating streaming media content is improved.

In some embodiments, the streaming media content may be a combination of a video stream and an audio stream. The server 160 obtains a content stream of a first type based on at least one of the first user input and the reference media content. In some embodiments, the content stream of the first type may be a content stream generated using a machine learning model. As an example, the first user input and the reference media content may be provided to the machine learning model, to obtain the content stream of the first type output by the machine learning model. In some embodiments, the content stream of the first type may be determined from a plurality of pre-generated content streams. As an example, the target content stream corresponding to the first user input may be determined from the plurality of pre-generated content streams by keyword retrieval or pattern matching. In some embodiments, the target content stream corresponding to the first user input may be determined by using a machine learning model.

Subsequently, a content stream of a second type that is at least partially complementary to the content stream of the first type is generated based on the content stream of the first type and at least one of the first user input or the reference media content. The content stream of the first type and the content stream of the second type are combined as at least a portion of the streaming media content. As an example, the content stream of the first type may be an audio stream. The audio stream may be determined based on the reference media content and the first user input. Subsequently, a video stream complementary to the audio stream is generated based on the audio stream, the first user input, and the reference media content. The audio stream and the video stream are combined into the streaming media content.

In some embodiments, the streaming media content is presented in a chat of a user with a digital assistant. As an example, the chat between the digital assistant 130 and the user may be a voice call. In this case, the streaming media content may be presented in a voice call interface. FIG. 2 shows a schematic diagram of an example interface 200 for presenting the streaming media content according to some embodiments of the present disclosure. As shown in FIG. 2, the example interface 200 includes an interaction entry 210, a content presentation area 220 for presenting the streaming media content, a state identification 230 for indicating the current operating state of the digital assistant, and a text display control 240. The interaction entry 210 is configured to acquire an interactive operation of the user for the digital assistant (such as an operation to start a voice call, an operation to end a voice call, etc.). As an example, the interaction entry 210 may include an audio control 211 for turning on or off the audio, a voice call control 212 for turning on or off the voice call, and a video control 213 for turning on or off the video. The text display control 240 is configured to control whether to present text related to the streaming media content. If it is detected that the text display control 240 is triggered, text related to the currently presented media content may be presented in the content presentation area 220. In some embodiments, the example interface 200 may further include an upload control. If it is detected that the upload control is triggered, an entry for the user to upload the media content is presented.

The operating state of the digital assistant 130 may include an input state indicative of obtaining a user input, an output state of presenting streaming media content, and so on. The user input may be various types of information, such as information related to questions, queries. For example, the user input may be an interaction message issued to the digital assistant.

In some embodiments, a first portion of the streaming media content is generated during a chat of the user with the digital assistant based on a first user input of the user to the digital assistant. For example, the user may provide voice input by continuously triggering the voice call control 212.

The streaming media content presented by the terminal device is the streaming media content that is already generated currently. For example, if a first portion of streaming media content has been currently generated, the first portion is presented. If a second portion of the streaming media content has been currently generated, and the first portion of the streaming media content has been presented, the second portion of the streaming media content is presented sequentially. If a third portion of the streaming media content has been generated during the presentation of the second portion of the streaming media content, the third portion of the streaming media content is presented sequentially. In this way, a new chat does not need to be started frequently, and the efficiency of providing services for the user by the voice assistant can be improved. In some embodiments, the reference media content and the streaming media content may be presented in conjunction in the content presentation area 210 to facilitate the user to determine whether the uploaded reference media content is correct.

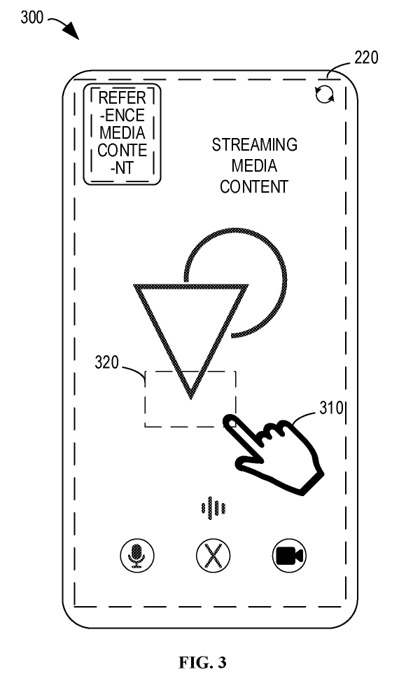

FIG. 3 shows a schematic diagram of another example interface 300 for presenting streaming media content according to some embodiments of the present disclosure. As shown in FIG. 3, the streaming media content may be presented in the content presentation area 220. In some embodiments, each frame of the streaming media content may include a large amount of information, and the user cannot determine the key content in the current streaming media content in a short time. To more accurately present the streaming media content, prompt information 310 may be presented in the content presentation area 220. The prompt information 310 is used to identify a specified area 320 in the streaming media content. The specified area 320 is the key content corresponding to the current content stream. As an example, if the streaming media content is media content combined with a video stream and an audio stream, the prompt information 310 may indicate an area in the current frame of the video stream corresponding to the audio stream. For example, if the “triangle vertex” is currently talked about, the prompt information 310 indicates the vertex of the triangle in the current frame. In some embodiments, reference media content may be presented in the interface 300 as a reference for the streaming media content. As shown in FIG. 3, the streaming media content provided by the digital assistant 130 may be generated based on the reference media content. As an example, if the user service request is to provide the solution of a test question and the first user input includes an image of the test question, the streaming media content may be generated based on the image of the test question provided by the user, for example, both the streaming media content presented by the interface 300 and the reference media content presented by the interface 200 include the image of the test question. In some embodiments, the reference media content may be indicated by the user in various suitable ways.

In some embodiments, during presentation of the streaming media content, an interaction operation by the user for the streaming media content may be received. The interaction operation of the user may be directed to one or more elements included in the streaming media content. The interaction operation indicates a desire of the user for the streaming media content or new needs of the user. During presentation of the streaming media content, a second portion of the streaming media content after the first portion is generated based on a user interaction associated with the streaming media content. The user interactions may include various forms of interactions. In some embodiments, the user interaction associated with the streaming media content may include voice or text. For example, the user may issue a voice input or a text input in a chat of a real-time call. Alternatively or additionally, in some embodiments, the user interaction associated with the streaming media content may include providing media content. For example, a user may indicate a content such as an image, a video, and an audio in a chat of a real-time call.

In some embodiments, if a user interaction associated with the streaming media content is not detected, a second portion of the streaming media content may be generated based on the first user input, the reference media content, and the first portion of the streaming media content that has been generated. In some embodiments, presentation of the streaming media content stops if the streaming media content for the first user input and the user interaction has been fully presented and no new user interaction is detected.

In some embodiments, as mentioned above, the user interaction may include voice or text. During presentation of the streaming media content, a second portion of the streaming media content is generated based on the second user input and the first portion of the streaming media content if a second user input is detected to be received for one or more elements included in the first portion. In some embodiments, target content presented at the receiving time of the second user input may be determined from the second portion. As an example, the target content corresponding to the second user input may be determined based on a keyword (for example, a keyword indicating an element or a keyword indicating a time) in the second user input. For example, the second user input may be provided to the language model to determine the semantics of the second user input, thereby determining the target content based on the semantics. In an example scenario, if the answer video includes a step of drawing the auxiliary line, the user interaction may be “please tell me how to draw the auxiliary line”, and the element corresponding to the user interaction is “auxiliary line”. The user interaction may also be “please zoom in to display the geometric figure displayed at the 12th minute”, and the element corresponding to the user interaction is “geometric figure at the 12th minute”.

In some embodiments, as mentioned above, a user interaction may include indicating media content. During presentation of the streaming media content, the updated reference media content indicated by the user may be received. Based on the updated reference media content, a second portion is generated. As an example, during presenting the streaming media content, a user may upload a video stream or an audio stream. In this case, the second portion of the streaming media content may be generated based on the video stream or audio stream uploaded by the user.

In some embodiments, the reference media content indicated by the user during the user interaction may be streaming, e.g., the user may shoot a video during a chat. Such reference media content may also be referred to as streaming reference media content. In such embodiments, the generated streaming media content may vary based on the streaming reference media content. For example, the first portion of the generated streaming media content is generated based on the first portion of the streaming reference media content, the second portion of the generated streaming media content is generated based on the second portion of the streaming reference media content, and so on. As an example scenario, the user shoots various plants seen in real time during a chat. Correspondingly, the generated streaming media content sequentially introduces the various plants which have been shot.

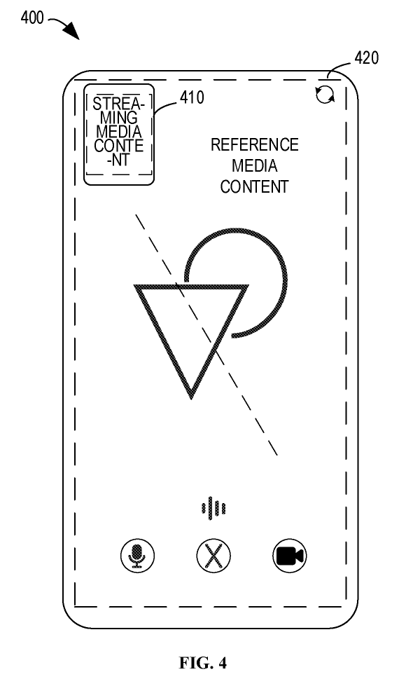

In some embodiments, to facilitate a user for viewing, updated reference media content and streaming media content may be presented in different regions in the page. FIG. 4 shows a schematic diagram of a further example interface 400 for presenting streaming media content according to some embodiments of the present disclosure. The interface 400 includes a first area 410 for presenting the streaming media content and a second area 420 for presenting the updated reference media content. As shown in FIG. 4, if the presented streaming media content includes a step of drawing an auxiliary line, the image or video including the auxiliary line drawn by the user may be used as the updated reference media content to generate the second portion of the streaming media content.

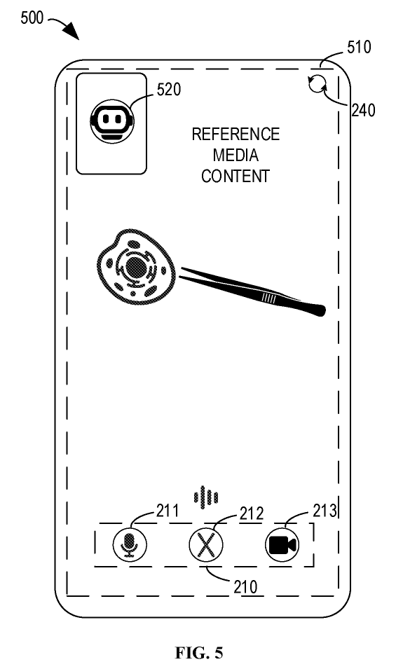

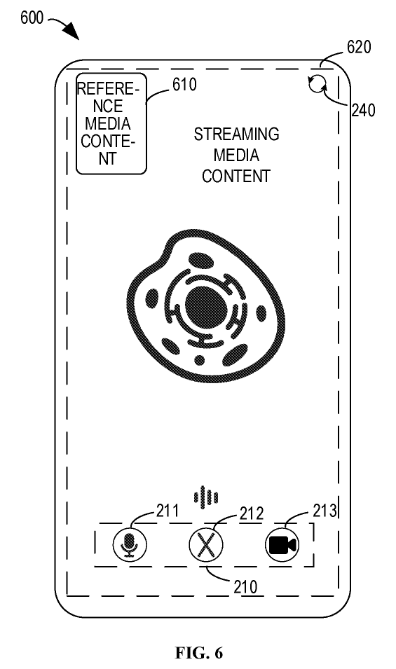

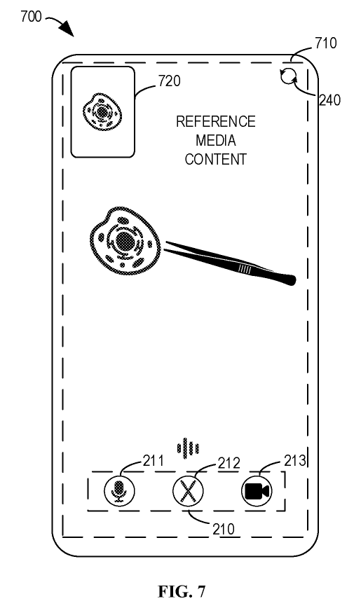

FIGS. 5-7 show schematic diagrams of second example interfaces 500 to 700 for presenting streaming media content according to some embodiments of the present disclosure. As shown in FIG. 5, if the user service request is guiding a chemical experiment, and the first user input includes content related to chemical experiment (e.g., an experimental requirement, experimental material information, etc.), the digital assistant 130 may generate streaming media content related to experimental guidance for the user based on the user request and the obtained information related to the request. As shown in FIG. 6, the interface 600 includes a first area 610 for presenting reference media content and a second area 620 for presenting streaming media content. As an example, if the chemical experiment is related to a cell, the second area 620 may include detailed structural information of the cell. The user may obtain guidance information related to the chemical experiment according to the streaming media content presented in the second area 620. In this case, the streaming media content provided by the digital assistant 130 need not depend on the reference media content provided by the user (i.e., an image of a test bed, an image of an experimental tool and the like included in reference media content 510). The streaming media content presented by the interface 600 does not have the same picture as the reference media content presented by the interface 500. In some embodiments, the digital assistant 130 may generate new streaming media content according to the interaction provided by the user for the streaming media content. As shown in FIG. 7, the interface 700 includes a first area 710 for presenting reference media content and a second area 720 for presenting streaming media content. The digital assistant 130 generates a next portion of the streaming media content based on the user interaction with a certain portion of the streaming media content (i.e., the interaction corresponding to the streaming media content presented by the second area 720).

In some embodiments, during presentation of the streaming media content, if no further user interaction is detected for the second portion, presentation is switched back to the first portion of the streaming media content after the presentation of the second portion ends. As an example, if the user asks the digital assistant how to draw the auxiliary line in the problem-solving video, the explanation video about drawing the auxiliary line may be presented. During presentation of the explanation video, if no further user interaction is detected, the problem-solving video continues to be presented.

In some embodiments, the content update frequency for the streaming media content may be determined based on the reference media content. In some embodiments, different content update frequencies may be determined for different types of reference media content. For example, if the reference media content is content of a static type (such as an image, etc.), the content update frequency is a first predetermined frequency which is a lower frequency. If the reference media content is content of a dynamic type (such as video or audio, etc.), it indicates that the user may be more demanding a more real-time interaction experience, and thus a higher second predetermined frequency needs to be used as the content update frequency. The second predetermined frequency is greater than the first predetermined frequency. In some embodiments, the content update frequency may be determined based on different application scenarios of the reference media content. As an example, if the streaming media content is related to a topic, during viewing the streaming media content, the user may have more user interactions, and the content update frequency is higher. If the streaming media content is related to news, there may be less user interaction, and the content update frequency is lower. During presentation of the streaming media content, a user interaction is detected in a real-time call at a content update frequency.

It can be seen that according to the solution of the present disclosure, if the pure voice or text reply fails to meet the user requirement, the streaming media content can be used to more intuitively reply to the user. In addition, such streaming media content is determined based on reply key points for the user input and thus can provide an associated solution for the user input. In this way, a more pertinent reply can be provided to the user input. Therefore, the service accuracy and user experience provided by the digital assistant are improved. Further, the next portion of the streaming media content may be generated based on the user interaction to improve the quality of a reply by the digital assistant. At the same time, the next portion of the streaming media content is generated during the streaming media content presentation, ensuring continuous presentation of the streaming media content. Further, the content update frequency is determined according to the reference media content to determine the frequency of obtaining the user interaction. Therefore, without affecting the interaction between the user and the streaming media content, the frequency of obtaining the user interaction and the updating frequency of the streaming media content are reduced to reduce the waste of computing resources.

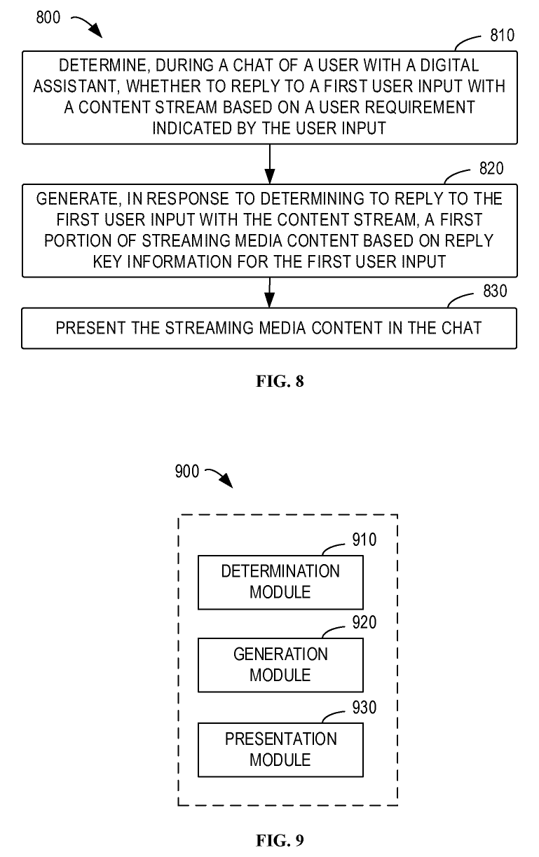

FIG. 8 shows a flowchart of a real-time interaction process 800 according to some embodiments of the present disclosure. For ease of discussion, the process 800 will be described with reference to the environment 100 of FIG. 1. The process 800 may be implemented at the server 160 or the terminal device 110, or may be implemented by the server 160 in cooperation with the terminal device 110.

At block 810, during a chat of a user with a digital assistant, whether to reply to a first user input with a content stream is determined based on a user requirement indicated by the first user input.

In some embodiments, the chat includes a voice call of the user with the digital assistant, and the first user input includes a first voice input of the user.

At block 820, in response to determining to reply to the first user input with the content stream, a first portion of streaming media content is generated based on reply key information for the first user input.

In some embodiments, the first user input includes reference media content provided by the user, and generating the first portion of the streaming media content includes: obtaining reply key information based on the reference media content; providing the reply key information and the reference media content to a machine learning model; and obtaining a video output by the machine learning model as the first portion.

In some embodiments, generating the first portion of the streaming media content includes: obtaining a content stream of the first type based on the first user input; generating a content stream of second type that is at least partially complementary to the content stream of the first type based on the reply key information and the content stream of the first type; and combining the content stream first type and the content stream of second type into the first portion of the streaming media content.

At block 830, the streaming media content is presented in the chat.

In some embodiments, the process 800 further includes: receiving a user interaction associated with the first portion of the streaming media content during presentation of the streaming media content; and generating a second portion of the streaming media content that is after the first portion based on the user interaction.

In some embodiments, generating the second portion includes: receiving, during presentation of the streaming media content, a second user input issued for one or more elements comprised in the first portion; and generating the second portion based on the second user input and the first portion.

In some embodiments, generating the second portion based on the second user input and the first portion includes: determining, from the second portion, target content presented at a receiving time of the second user input; and generating the second portion based on the second user input and the target content.

In some embodiments, the first user input includes reference media content provided by the user, and generating the second portion includes: receiving, during presentation of the streaming media content, updated reference media content indicated by the user; and generating the second portion based on the updated reference media content.

In some embodiments, the first user input includes reference media content provided by the user, and the user interaction is determined by: determining a content update frequency for the streaming media content based on a type of the reference media content; and detecting, during presentation of the streaming media content, the user interaction in the real-time call at the content update frequency.

In some embodiments, determining the content update frequency for the streaming media content includes: determining a first predetermined frequency as the content update frequency in response to the reference media content being content of a static type; and determining a second predetermined frequency as the content update frequency in response to the reference media content being content of a dynamic type, wherein the second predetermined frequency is greater than the first predetermined frequency.

In some embodiments, the process 800 further includes: detecting, during presentation of the second portion, a further user interaction for the second portion; and switching, in response to failing to detect the further user interaction, back to presenting the first portion of the streaming media content after completion of the presentation of the second portion.

Embodiments of the present disclosure also provide a corresponding apparatus for implementing the above method or process. FIG. 9 shows an example structural block diagram of an apparatus 900 for real-time interaction according to some embodiments of the present disclosure. The apparatus 900 may be implemented or included in the client device 110 and/or the server 190. The various modules/components in the apparatus 900 may be implemented by hardware, software, firmware, or any combination thereof.

As shown in FIG. 9, the apparatus 900 includes a determination module 910 configured to determine, during a chat of a user with a digital assistant, whether to reply to a first user input with a content stream based on a user requirement indicated by the first user input. The apparatus 900 further includes a generation module 920 configured to generate, in response to determining to reply to the first user input with the content stream, a first portion of streaming media content based on reply key information for the first user input. The apparatus 900 further includes a presentation module 930 configured to present the streaming media content in the chat.

In some embodiments, the generation module 920 is further configured to: obtain the reply key information based on the reference media content; provide the reply key information and the reference media content to a machine learning model; and obtain a video output by the machine learning model as the first part.

In some embodiments, the generation module 920 is further configured to: obtain a content stream of the first type based on the first user input; generate a content stream of second type that is at least partially complementary to the content stream of the first type based on the reply key information and the content stream of the first type; and combine the content stream of the first type and the content stream of second type into the first portion of the streaming media content.

In some embodiments, the chat includes a voice call of the user with the digital assistant, and the first user input includes a first voice input of the user.

In some embodiments, the apparatus 900 further includes an interaction receiving module configured to receive a user interaction associated with the first portion of the streaming media content during presentation of the streaming media content; and generate a second portion of the streaming media content that is after the first portion based on the user interaction.

In some embodiments, the interaction receiving module is further configured to receive, during presentation of the streaming media content, a second user input issued for one or more elements comprised in the first portion; and generate the second portion based on the second user input and the first portion.

In some embodiments, the interaction receiving module is further configured to determine target content presented at a receiving time of the second user input from the second portion; and generate a second portion based on the second user input and the target content.

In some embodiments, the interaction receiving module is further configured to receive, during presentation of the streaming media content, updated reference media content indicated by the user; and generate a second portion based on the updated reference media content.

In some embodiments, the first user input includes reference media content provided by the user, and the interaction receiving module is further configured to determine a content update frequency for the streaming media content based on the type of reference media content; and detect, during presentation of the streaming media content, the user interaction in the real-time call at the content update frequency.

In some embodiments, the interaction receiving module is further configured to, in response to the reference media content being content of a static type, determine a first predetermined frequency as the content update frequency; and determine, in response to the reference media content being content of a dynamic type, a second predetermined frequency as the content update frequency, wherein the second predetermined frequency is greater than the first predetermined frequency.

In some embodiments, the apparatus 900 further includes a switching module configured to detect, during presentation of the second portion, a further user interaction for the second portion; and switch, in response to failing to detect the further user interaction, back to presenting the first portion of the streaming media content after completion of the presentation of the second portion.

The units and/or modules included in the apparatus 900 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, a portion of or all of the units and/or modules in the apparatus 600 may be implemented, at least partially, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may include, for example, devices running the system management platform 110 in FIG. 1.

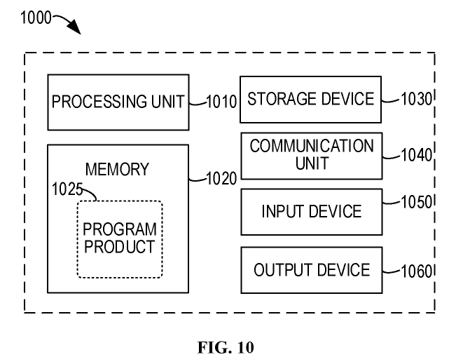

FIG. 10 shows a block diagram of an electronic device 1000 in which one or more embodiments of the present disclosure may be implemented. It should be understood that the electronic device 1000 shown in FIG. 10 is merely an example and should not constitute any limitation on the functionality and scope of the embodiments described herein. The electronic device 1000 shown in FIG. 10 may include or be implemented as the system management platform 110 of FIG. 1 or the apparatus 600 of FIG. 6.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and capable of performing various processes according to programs stored in the memory 1020. In multiprocessor systems, multiple processing units execute computer-executable instructions in parallel to improve parallel processing capabilities of the electronic device 1000.

The electronic device 1000 typically includes a plurality of computer storage media. Such media may be any available media accessible to the electronic device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 1030 may be a removable or non-removable medium and may include a machine-readable medium, such as a flash drive, magnetic disk, or any other medium, which may be capable of storing information and/or data and may be accessed within the electronic device 1000.

The electronic device 1000 may further include additional removable/non-removable, volatile/non-volatile storage media. Although not shown in FIG. 10, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1020 may include a computer program product 1025 having one or more program modules configured to perform various methods or actions of various embodiments of the present disclosure.

The communication unit 1040 is configured to communicate with another electronic device through a communication medium. Additionally, the functionality of components of the electronic device 1000 may be implemented in a single computing cluster or multiple computing machines capable of communicating over a communication connection. Thus, the electronic device 1000 may operate in a networked environment using logical connections of one or more other servers, network personal computers (PCs), or another network node.

The input device 1050 may be one or more input devices, such as a mouse, a keyboard, a trackball, or the like. The output device 1060 may be one or more output devices, such as a display, a speaker, a printer, or the like. The electronic device 1000 may also communicate with one or more external devices (not shown) through the communication unit 1040 as needed, external devices such as storage devices, display devices, etc. , communicate with one or more devices that enable a user to interact with the electronic device 1000, or communicate with any device (e.g., a network card, a modem, etc. ) that enables the electronic device 1000 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

According to example implementations of the present disclosure, a computer program product or a computer program is provided, where the computer program product or the computer program includes computer instructions, and the computer instructions are stored in a computer-readable storage medium. The processor of the computer device reads the computer instruction from the computer-readable storage medium, and the processor executes the computer instruction, so that the computer device performs the method provided in various optional manners in FIG. 10, and therefore, details are not described herein again.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, dedicated purpose computer, or other programmable data processing apparatus to produce a machine, such that the instructions, when executed by a processing unit of a computer or other programmable data processing apparatus, produce an apparatus to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement various aspects of the functions/acts specified in the one or more blocks of the flowchart and/or block diagram (s).

The computer-readable program instructions may be loaded onto a computer, other programmable data processing apparatus, or other device, such that a series of operational steps are performed on a computer, other programmable data processing apparatus, or other device to produce a a process of computer implementation such that the instructions executed on a computer, other programmable data processing apparatus, or other apparatus implement the functions/acts specified in the one or more blocks of the flowchart and/or block diagram.

The flowchart and block diagrams in the accompanying drawings show architecture, functionality, and operation of possible implementations of systems, methods, and computer program products according to a plurality of implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the accompanying drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

While various implementations of the present disclosure have been described above, the foregoing illustration is an example and not exhaustive, and the present disclosure is not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for real-time interaction, comprising:
determining, during a chat of a user with a digital assistant, whether to reply to a first user input with a content stream based on a user requirement indicated by the first user input;
generating, in response to determining to reply to the first user input with the content stream, a first portion of streaming media content based on reply key information for the first user input; and
presenting the streaming media content in the chat.

2. The method of claim 1, further comprising:
receiving a user interaction associated with the first portion of the streaming media content during presentation of the streaming media content; and
generating a second portion of the streaming media content that is after the first portion based on the user interaction.

3. The method of claim 2, wherein generating the second portion comprises:
receiving, during presentation of the streaming media content, a second user input issued for one or more elements comprised in the first portion; and
generating the second portion based on the second user input and the first portion.

4. The method of claim 3, wherein generating the second portion based on the second user input and the first portion comprises:
determining, from the second portion, target content presented at a receiving time of the second user input; and
generating the second portion based on the second user input and the target content.

5. The method of claim 2, wherein the first user input comprises reference media content provided by the user, and generating the second portion comprises:
receiving, during presentation of the streaming media content, updated reference media content indicated by the user; and
generating the second portion based on the updated reference media content.

6. The method of claim 2, wherein the first user input comprises reference media content provided by the user, and the user interaction is determined by:
determining a content update frequency for the streaming media content based on a type of the reference media content; and
detecting, during presentation of the streaming media content, the user interaction in the chat at the content update frequency.

7. The method of claim 6, wherein determining the content update frequency for the streaming media content comprises:
determining a first predetermined frequency as the content update frequency in response to the reference media content being content of a static type; and
determining a second predetermined frequency as the content update frequency in response to the reference media content being content of a dynamic type, wherein the second predetermined frequency is greater than the first predetermined frequency.

8. The method of claim 2, further comprising:
detecting, during presentation of the second portion, a further user interaction for the second portion; and
switching, in response to failing to detect the further user interaction, back to presenting the first portion of the streaming media content after completion of the presentation of the second portion.

9. The method of claim 1, wherein the first user input comprises reference media content provided by the user, and generating the first portion of the streaming media content comprises:
obtaining the reply key information based on the reference media content;
providing the reply key information and the reference media content to a machine learning model; and
obtaining a video output by the machine learning model as the first portion.

10. The method of claim 1, wherein generating the first portion of the streaming media content comprises:
obtaining a content stream of a first type based on the first user input;
generating a content stream of a second type that is at least partially complementary to the content stream of the first type based on the reply key information and the content stream of the first type; and
combining the content stream of the first type and the content stream of the second type into the first portion of the streaming media content.

11. The method of claim 1, wherein the chat comprises a voice call of the user with the digital assistant, and the first user input comprises a first voice input by the user to the digital assistant.

12. An electronic device, comprising:
at least one processor; and
at least one memory coupled to the at least one processor and storing instructions executed by the at least one processor, the instructions, when executed by the at least one processor, causing the electronic device to perform acts comprising:
determining, during a chat of a user with a digital assistant, whether to reply to a first user input with a content stream based on a user requirement indicated by the first user input;
generating, in response to determining to reply to the first user input with the content stream, a first portion of streaming media content based on reply key information for the first user input; and
presenting the streaming media content in the chat.

13. The device of claim 12, wherein the acts further comprise:
receiving a user interaction associated with the first portion of the streaming media content during presentation of the streaming media content; and
generating a second portion of the streaming media content that is after the first portion based on the user interaction.

14. The device of claim 13, wherein generating the second portion comprises:
receiving, during presentation of the streaming media content, a second user input issued for one or more elements comprised in the first portion; and
generating the second portion based on the second user input and the first portion.

15. The device of claim 14, wherein generating the second portion based on the second user input and the first portion comprises:
determining, from the second portion, target content presented at a receiving time of the second user input; and
generating the second portion based on the second user input and the target content.

16. The device of claim 13, wherein the first user input comprises reference media content provided by the user, and generating the second portion comprises:
receiving, during presentation of the streaming media content, updated reference media content indicated by the user; and
generating the second portion based on the updated reference media content.

17. The device of claim 13, wherein the first user input comprises reference media content provided by the user, and the user interaction is determined by:
determining a content update frequency for the streaming media content based on a type of the reference media content; and
detecting, during presentation of the streaming media content, the user interaction in the chat at the content update frequency.

18. The device of claim 17, wherein determining the content update frequency for the streaming media content comprises:
determining a first predetermined frequency as the content update frequency in response to the reference media content being content of a static type; and
determining a second predetermined frequency as the content update frequency in response to the reference media content being content of a dynamic type, wherein the second predetermined frequency is greater than the first predetermined frequency.

19. The device of claim 13, wherein the acts further comprise:
detecting, during presentation of the second portion, a further user interaction for the second portion; and
switching, in response to failing to detect the further user interaction, back to presenting the first portion of the streaming media content after completion of the presentation of the second portion.

20. A non-transitory computer-readable storage medium having computer programs stored thereon, wherein the computer programs are executable by a processor to implement a method for real-time interaction, the method comprising:
determining, during a chat of a user with a digital assistant, whether to reply to a first user input with a content stream based on a user requirement indicated by the first user input;
generating, in response to determining to reply to the first user input with the content stream, a first portion of streaming media content based on reply key information for the first user input; and
presenting the streaming media content in the chat.
